(19) United States
(12) Patent Application Publication
(10) Pub. No.: US 2024/0417326 A1
(43) Pub. Date: Dec. 19, 2024

(54) Carbon-Absorbing Algae Concrete and Method of Production

(71) Applicant: Michael Lafave, Denver, CO (US)

(72) Inventor: Michael Lafave, Denver, CO (US)

(21) Appl. No.: 18/814,312

(22) Filed: Aug. 23, 2024

Related U.S. Application Data
(63) Continuation-in-part of application No. 18/722,678, filed on Jan. 1, 0001.
(60) Provisional application No. 63/469,108, filed on May 26, 2023.

(51) Int. Cl. C04B 24/38; C04B 12/00; C04B 18/06; C04B 18/08; C04B 111/10; C04B 111/20

(52) U.S. Cl. CPC C04B 24/38; C04B 12/005; C04B 18/067; C04B 18/08; C04B 2111/1093; C04B 2111/29

(57) ABSTRACT

A carbon-sequestering geopolymer concrete composition and method of manufacture is disclosed. The composition comprises a geopolymeric binder phase of aluminosilicate materials and an alkaline activator, coarse and fine aggregates, dried marine algae powder, and optional supplementary cementitious materials. This enables significantly reduced carbon dioxide emissions during production compared to standard concrete mixes. Additionally, the integrated algae powder facilitates direct capture and mineralization of atmospheric carbon dioxide as the concrete cures. Aspects of embodiments of the invention include the concrete composition; a sidewalk embodiment comprising said concrete; associated sidewalk construction methods; and alternate sidewalk embodiment claims. Compared to conventional concretes, the technology disclosed herein provides over 70% lower CO2 emissions coupled with enhanced carbon mineralization that progresses over the material lifetime. This enables various infrastructure applications to reach carbon-absorbing or carbon-negative performance credentials. The composition also exhibits excellent mechanical strength, freeze-thaw resilience, and extended durability properties.

### CROSS REFERENCE TO RELATED APPLICATIONS

This application claims the benefit of and is a continuation in part of U.S. Nonprovisional patent application Ser. No. 18/722,678 filed on Jun. 21, 2024, which claims the benefit of Patent Cooperation Treaty patent application PCT/US2024/013913 filed on Feb. 1, 2024, which claims the benefit of U.S. Provisional Patent Application 63/469,108 filed on May 26, 2023, each of which are incorporated by reference in their entirety.

### BACKGROUND OF THE INVENTION

Annually, over 4 billion metric tons of conventional Portland cement concrete are produced globally, making it the world's most consumed material after water. However, manufacturing the Portland cement binder alone accounts for 7-8% of all carbon dioxide emissions worldwide. This represents an immense environmental burden directly tied to concrete usage across buildings, infrastructure and construction, generating over 2 gigatons of carbon dioxide (CO2) per year during cement production. Mitigating these enormous emissions by creating concrete that can actively absorb and mineralize atmospheric carbon has emerged as a promising climate change mitigation strategy. Recent advances have attempted to enable CO2 sequestration in concrete by incorporating seawater at various steps of the mixing process before curing. Seawater contains dissolved calcium, magnesium, and carbonates that can bond with absorbed CO2 to form stable carbonates. However, existing seawater approaches have achieved only modest, inconsistent levels of CO2 absorption that pale in comparison to the scale of emissions from concrete production. Substantial challenges remain in translating proof-of-concept carbon-absorbing concrete methods into commercially viable, scalable solutions for the $300 billion per year concrete industry. Major limitations on supply logistics, absorption kinetics, and mineral delivery continue to restrict widespread adoption of carbon-absorbing concrete technology.

For example, the concrete volumes required to build a typical high-rise tower can generate over 150,000 tons of CO2 emissions solely from the concrete production. Additionally, a typical 4-lane highway stretching 1 mile long requires 25 million lbs. of concrete, indirectly emitting around 24 million lbs. of CO2 through its binder manufacturing. Sidewalk construction further substantially exacerbates emissions.

The concrete industry has long grappled with the challenge of reducing its substantial carbon footprint while maintaining the structural integrity and performance of its products. Traditional Portland cement-based concretes are significant contributors to global CO2 emissions, with cement production alone accounting for approximately 7-8% of worldwide carbon dioxide emissions. While some concrete manufacturers have made claims of carbon negativity, these assertions often rely on minimal reductions that amount to fractions of a decimal point in terms of overall environmental impact. This approach falls short of addressing the urgent need for substantial greenhouse gas reductions in the construction sector. Furthermore, the industry has struggled to develop a cost-effective, scalable solution that can achieve significant carbon sequestration without compromising the mechanical properties and durability of the concrete. The lack of a truly carbon-negative concrete that can be produced at a competitive price point has hindered the widespread adoption of more sustainable construction practices, particularly in large-scale infrastructure and building projects where the environmental impact is most pronounced.

Beyond just the greenhouse gas impacts, conventional concrete also creates problems related to the raw materials needed in production. Harvesting the limestone, clay and shale used to make Portland cement contributes to depletion of finite natural resources and landscape damage. The lifecycle threats also extend to end-of-life, whereby spent traditional concrete often ends up in landfills without efficient recycling pathways currently available.

There is a substantial need within the construction sphere to mitigate the considerable sustainability issues tied to conventional concrete across all its major application areas. Achieving global emissions reductions targets requires transformative technologies to curb the environmental burdens created by buildings, roads and civic structures historically reliant on standard Portland cement-based concrete mixes.

A major compatibility issue arises when attempting to integrate existing CO2 absorption approaches into standard concrete manufacturing using Portland cement. Portland cement relies on carbonation reactions during curing, which interfere and compete with the additional CO2 absorption mechanisms. The calcium silicates in Portland cement undergo hydration and hardening reactions that release calcium ions, hydroxide ions, and heat. Therefore there remains a need for an improved solution.

The incorporation of Portland cement competes directly with the CO₂ absorbing properties associated with the setting of the concrete matrix. The interdependent chemical interactions with Portland cement chemistry make it challenging to achieve consistent, reliable CO2 sequestration. The varying conditions also cause wide fluctuations in total carbon absorption from one batch to another. This cement incompatibility remains a major unresolved barrier for adoption of existing carbon-absorbing techniques on an industrial scale using standard Portland cement-based concrete mixes. Concrete production using Portland cement in general remains a major contributor to CO2 emissions. It is estimated that for a typical 30-story building, approximately 160,000,000 lbs. of CO2 are released just from the concrete required, calculated based on approximately 158.8 million lbs. of concrete needed.

A major drawback of prior art approaches associated with CO2 sequestering concrete that utilize seawater for CO2 absorption is the substantial transportation costs and logistical barriers associated with obtaining and delivering large volumes of seawater to inland construction sites. Seawater has relatively low concentrations of the reactive minerals needed for meaningful CO2 sequestration. Typical seawater is only about 3.5% dissolved salts by weight, requiring extremely large quantities of water to contribute enough calcium, magnesium, and other minerals to enable adequate carbon dioxide absorption as the concrete cures. Transporting such enormous volumes of seawater hundreds or thousands of miles inland from coastal areas would require specialized containers and trucks as well as significant fuel for delivery. Even with costly transportation infrastructure, the supply and rate of deliveries may be insufficient to support high volume concrete pours. Additionally, most concrete batch plants do not have existing infrastructure to unload, store, and process such large water volumes on site. These transportation and logistics constraints impose major economic and operational limitations for adopting seawater-based carbon absorption approaches in commercial ready mix concrete production, especially for construction projects far from the coastline.

Another significant challenge with existing seawater-based techniques for CO2-absorbing concrete is the slow speed and low efficiency of carbon dioxide absorption. Seawater relies on natural diffusion of CO2 gas molecules into stagnant microscopic water pockets dispersed within the concrete matrix. However, the rate of diffusion is extremely slow compared to the chemical bonding potential of reactive mineral ions. This disparity in absorption speed versus bonding speed during curing severely limits the overall CO2 uptake capacity. There is an abundance of dissolved calcium, magnesium, and other minerals in seawater that could chemically bind large amounts of CO2 if the gas could access and react with the ions. But the slow, uncontrolled diffusion process restricts absorption of CO2 to levels far below what could be achieved with faster kinetics. Consequently, existing seawater-based approaches fail to fully leverage the CO2 absorption potential of the seawater salts, restricting their carbon uptake and negation capabilities.

Attempts have also been made to utilize freshwater algae for CO2 sequestration in concrete, but these have achieved limited success. Freshwater algae lack many of the cellular adaptations that enable marine saltwater algae to be highly effective carbon sinks. Marine saltwater environments require algae to evolve robust cell walls with concentrated salts and carbon-binding structures tuned for ocean conditions. Freshwater species do not face the same selective pressures, so their cell walls are relatively fragile and have lower innate CO2 affinity. As a result, freshwater algae release fewer reactive minerals and absorb markedly less CO2 upon rehydration in curing concrete when compared to marine algae. The far lower performance coupled with supply constraints from freshwater algae farming make these unsuitable for scalable, high-efficiency CO2 sequestration in concrete.

In summary, while incorporating seawater and algae into concrete mixes shows some promise for enabling CO2 mineralization, existing approaches have severe limitations that prevent widespread commercial adoption. Major compatibility issues arise when attempting to integrate current seawater and algae CO2 absorption techniques with standard concrete manufacturing using Portland cement. Additionally, substantial logistics barriers exist for obtaining the large volumes of seawater needed. And the slow seawater diffusion kinetics restrict overall CO2 uptake rates and capacity. These deficiencies result in inconsistent, modest levels of carbon absorption that are dwarfed by the scale of emissions from industrial concrete production. Therefore, there remains a need for an improved invention that can enhance CO2 sequestration within concrete while overcoming the transport, reactivity, and cement compatibility challenges that continue to restrict the viability of existing methods. Such an invention could provide a scalable pathway to transforming a major CO2 emission source into a carbon sink, enabling broader adoption of eco-friendly construction materials with a reduced carbon footprint.

### SUMMARY OF THE INVENTION

Embodiments of the invention transforms conventional carbon-emitting concrete into an eco-friendly construction material that actively absorbs carbon dioxide from the air. It leverages a novel composition and manufacturing method to reduce the carbon footprint of concrete in two ways—by curtailing emissions from production and enabling direct CO2 removal during curing of the concrete.

In association with an embodiment, rather than using traditional Portland cement, the disclosed concrete composition 100 and associated methods of manufacture utilize industrial byproducts known as geopolymers, such as slag and fly ash, as the primary binder. The use of these waste materials not only reduces landfill loading, but also decreases CO2 emissions from cement production by up to 80%. To enable renewable post-installation carbon absorption, the novel mixture also incorporates dried marine saltwater algae powder in association with an embodiment. As the concrete cures, the dried algae rehydrates and reacts with atmospheric CO2 through natural mineralization processes optimized for high uptake capacity.

The environmental benefits associated with the disclosed embodiments are numerous. For example, in association with prior art technologies, for a typical 30-story building, approximately 160 million pounds of carbon dioxide are released just from the required concrete using regular Portland cement. In contrast, the use of geopolymer binders in association with an embodiment invention would curb over 127 million pounds of those emissions for the same building. Additionally, the integrated marine saltwater algae associated with the preferred embodiment further actively absorbs significant amounts of CO2 as the concrete cures. Taken together, these dual carbon impact mechanisms associated with the embodiments disclosed herein could reduce the net CO2 emissions as compared to the prior art by over 80%.

### BRIEF DESCRIPTION OF THE FIGURES

FIG. 1 depicts the usage of an embodiment of the invention in association with a sidewalk.

FIG. 2 depicts the usage of an embodiment of the invention in association with a pillar associated with a typical construction project.

### DETAILED DESCRIPTION

The present invention relates to a carbon-sequestering concrete composition 100 comprising a geopolymeric binder phase and an algae additive for enhanced carbon mineralization. The concrete is formed by combining algae biomass that has been dried and pulverized into a fine powder with a geopolymer precursor to produce a binder phase. Suitable geopolymer precursors include aluminosilicate materials such as fly ash, slag, metakaolin, or natural minerals rich in alkali metals. These are combined with an alkaline activator solution to induce geopolymerization reactions. The algae powder is then incorporated into this geopolymeric binder phase along with coarse and fine aggregates before curing. Through both the reduced reliance on traditional Portland cement and the inclusion of the carbon-mineralizing algal biomass, the disclosed concrete system exhibits significantly lower carbon footprints compared to conventional concretes. The composition also demonstrates excellent mechanical strength and durability properties for infrastructure and construction applications.

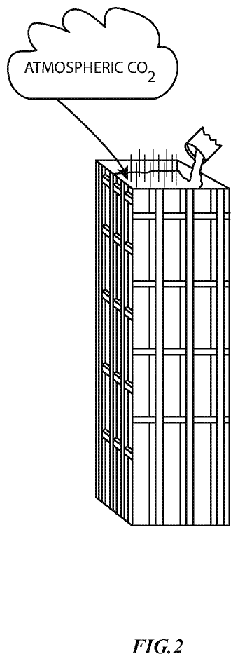

The carbon-sequestering geopolymer-algae concrete has particular utility for sustainable buildings, transportation infrastructure, and public works projects seeking to minimize environmental impacts from construction, including by the utilization of the concrete composition 100 in association with pillars associated with such projects as depicted in FIG. 2. High-performance structures can be erected using the present invention as the primary concrete for foundations, floors, walls and other load-bearing elements with enhanced durability compared to traditional mixes. For example, high-rise towers, commercial buildings, residential units and mixed-use developments can reduce their carbon footprint by over 70% using the disclosed concrete technology. Additionally, implementing the composition for roads, bridges, alleyways, sidewalks and parking garages facilitates improved lifecycle performance across civic construction initiatives. The present invention thereby enables the built environment's two largest consumers of concrete-buildings and infrastructure—to meaningfully curtail greenhouse emissions associated with critical urban growth and renewal efforts through adoption of the carbon-mineralizing geopolymer-algae concrete in their projects.

### Composition

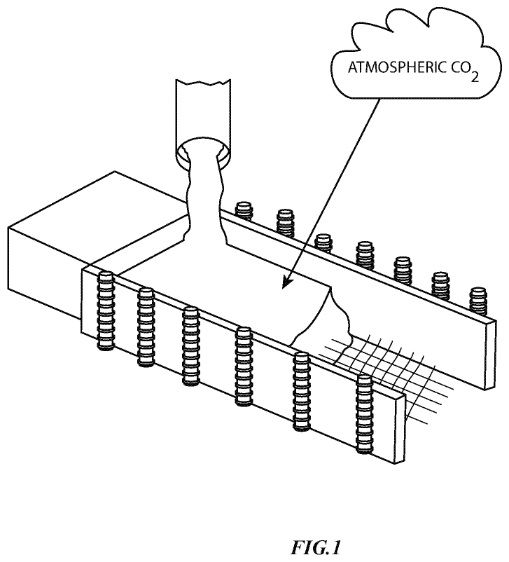

The disclosed carbon-absorbing geopolymer concrete leverages a specialized composition designed to reduce the carbon footprint of concrete structures, such as those depicted in FIGS. 1 and 2. It replaces traditional carbon-intensive Portland cement with industrial byproducts known as geopolymers. These geopolymers serve as the main binder to hold together concrete constituents and cure into a strong, durable matrix. The composition also incorporates dried marine algae powder, which enables the concrete to directly capture and mineralize carbon dioxide from the air as it cures.

The carbon-negative concrete composition utilizes a carefully balanced blend of raw materials to achieve both structural integrity and significant carbon sequestration capabilities in accordance with the preferred embodiment.

In accordance with various embodiments, the carbon-negative concrete composition described in the claim can be produced by carefully balancing the proportions of key ingredients to achieve optimal carbon sequestration and structural performance. The binder system, comprising Class F fly ash in a concentration of 7-13% of the total composition, ground granulated blast furnace slag (GGBFS) in a concentration of 5-10% of the total composition, and metakaolin in a concentration of 1-4% of the total composition, provides a robust geopolymeric matrix that significantly reduces CO2 emissions compared to traditional Portland cement. The use of recycled coarse aggregates and natural fine aggregates in a concentration of 35-45% each of the total composition further enhances the sustainability profile of the concrete while maintaining necessary structural properties. The alkaline activators, sodium hydroxide and sodium silicate solutions in a concentration of 1-4% each of the total composition, initiate the geopolymerization process, with their concentrations carefully controlled to optimize reactivity and workability.

The carbon sequestration additives, at least one or more of the group consisting of algae biomass, calcium carbonate, and magnesium carbonate in a concentration of 0.3-3% each of the total composition, along with at least one or more of the group consisting of olivine, basalt rock dust, biochar, and alginate beads in a concentration of 0.2-2.5% each of the total composition, work synergistically to capture and mineralize atmospheric CO2 during curing and throughout the concrete's service life. The water content in a concentration of 3-20% of the total composition is adjustable based on aggregate moisture and desired workability, playing a crucial role in achieving the optimal balance between strength development and carbon sequestration potential.

This composition is designed to reduce CO2 inputs by approximately 80-130 tons during production of concrete and capture an additional 150-250 tons of CO2 per 1,000 tons of concrete produced. This is achieved through multiple mechanisms, including the use of industrial byproducts as binders, the incorporation of carbon-absorbing additives, and the concrete's ability to actively sequester CO2 from the surrounding air during its curing phase and throughout its lifetime. The ranges provided in the claim allow for flexibility in adjusting the composition to suit specific project requirements while maintaining its significant carbon-negative properties.

The binder system, which comprises 190.5 tons per 1,000 tons of the total composition in the preferred embodiment, comprises 95.25 tons of Class F fly ash, 71.44 tons of ground granulated blast furnace slag (GGBFS), and 23.81 tons of metakaolin, each per 1,000 tons of the composition.

This combination of industrial byproducts and pozzolanic materials serves as an environmentally friendly alternative to traditional Portland cement, substantially reducing the carbon footprint associated with concrete production in accordance with the preferred embodiment.

The aggregate portion of the mix, totaling 809.5 tons per 1,000 tons of the composition, is equally divided between recycled coarse aggregates and natural fine aggregates, each contributing 404.75 tons per 1,000 tons of the composition. The use of recycled aggregates further enhances the sustainability profile of the concrete by reducing reliance on virgin materials and minimizing waste.

To activate the geopolymerization process, the mix incorporates 47.6 tons of alkaline activators per 1,000 tons of the composition, comprising equal parts sodium hydroxide solution (50% concentration) and sodium silicate solution (40% concentration), each at 23.8 tons per 1,000 tons of the composition. In an embodiment, potassium-based alternatives, specifically potassium hydroxide and potassium silicate, can be substituted for their sodium counterparts. The present inventor has recognized that while the potassium-based activators may offer enhanced carbon dioxide sequestration capabilities due to their higher pH, they also increase the overall cost of the concrete 100.

An embodiment of the carbon-negative concrete 100 comprises 47.6 tons of carbon sequestration additives per 1,000 tons of the composition in accordance with the preferred embodiment. This blend comprises 9.52 tons each of algae biomass, calcium carbonate, and magnesium carbonate per 1,000 tons of the concrete composition 100, along with 4.76 tons each of olivine, basalt rock dust, biochar, and alginate beads per 1,000 tons of the composition in accordance with the preferred embodiment. These additives work synergistically to capture and mineralize atmospheric carbon dioxide during the concrete's curing process and throughout its service life. The water content of the mix is approximately 71.4 tons per 1,000 tons of the composition, though this can be adjusted based on the moisture content of the aggregates and the desired workability of the fresh concrete when poured in accordance with the preferred embodiment. In accordance with embodiments, the water-to-binder ratio plays a crucial role in achieving the optimal balance between strength development and carbon sequestration potential.

The concrete formulation of the preferred embodiment offers significant environmental benefits compared to traditional Portland cement-based concretes. It reduces CO2 inputs by 107.75 tons per 1,000 tons of the composition and captures an additional 200 tons per 1,000 tons of the composition, resulting in a net reduction of approximately 95 tons of CO2 per 1,000 tons of concrete 100 produced in accordance with the preferred embodiment. This level of carbon negativity substantially outperforms many competing “carbon-negative” concrete products, which often claim such status based on much smaller fractions of CO2 reduction.

The carbon sequestration process accordance with the preferred embodiment of the concrete 100 occurs through multiple mechanisms. During the initial curing phase, which typically lasts 28-60 days, the concrete 100 actively absorbs CO2 from the surrounding air through direct air capture (DAC) in accordance with the preferred embodiment. Additionally, the concrete 100 can incorporate CO2 injections from various industrial sources, such as ethanol, ammonia, steel, and hydrogen production facilities, where CO2 is already captured in various forms. This approach not only enhances the concrete's 100 carbon sequestration capacity but also provides a beneficial recycling pathway for industrial CO2 emissions in accordance with embodiments. Embodiments of the composition can include recycled concrete aggregates (which may contain some residual Portland cement), the formulation is designed to be entirely Portland cement-free in accordance with the preferred embodiment. This further distinguishes it from many conventional concrete mixes and contributes to its superior environmental performance in comparison.

The versatility of the preferred embodiment of the invention comprising a carbon-negative concrete composition 100 allows for adjustments in the ratios of components to suit specific project requirements, such as the differences between a 25-story office building and a sidewalk. This flexibility ensures that the concrete 100 can be optimized for various applications while maintaining its carbon sequestration capabilities.

Another advantage of the composition in its preferred embodiment is cost-effectiveness, as the preferred embodiment of the carbon-negative concrete composition 100 is priced at approximately $118 per ton as measured in 2024, which compares favorably to traditional Portland cement concrete, typically priced between $125-240 per ton (excluding labor and energy costs) as measured in 2024. This competitive pricing, combined with its significant environmental benefits, positions the preferred embodiment of the concrete 100 as a viable and attractive option for sustainable construction projects across various scales and applications.

The carbon-negative concrete composition in its preferred embodiment in the quantities as described in the above disclosure distinguishes itself from other concretes claiming carbon negativity through its substantial and quantifiable impact on CO2 reduction. Unlike competing products that often base their carbon-negative claims on marginal reductions, this innovative formulation achieves a net reduction of approximately 95 tons of CO2 per 1,000 tons of concrete produced.

A method of producing an embodiment of the carbon-negative concrete composition described herein involves several steps that leverage innovative materials and processes to achieve significant carbon dioxide reduction. The process begins with the formation of a binder system by combining Class F fly ash, ground granulated blast furnace slag (GGBFS), and metakaolin. These industrial byproducts and pozzolanic materials serve as environmentally friendly alternatives to traditional Portland cement, substantially reducing the carbon footprint associated with concrete production.

The next step involves mixing recycled coarse aggregates and natural fine aggregates. The use of recycled aggregates further enhances the sustainability profile of the concrete by reducing reliance on virgin materials and minimizing waste. The precise ratio of these aggregates can be adjusted based on the specific requirements of the project, but typically, they are used in equal proportions.

To activate the geopolymerization process, sodium hydroxide solution (optionally 50% concentration) and sodium silicate solution (optionally 40% concentration) are added as alkaline activators. These activators play a crucial role in initiating the chemical reactions that form the concrete's strong and durable matrix.

A key feature of this carbon-negative concrete is the incorporation of carbon sequestration additives. These include one or more of algae biomass, calcium carbonate, magnesium carbonate, olivine, basalt rock dust, biochar, and alginate beads. Each of these additives contributes to the concrete's ability to capture and mineralize atmospheric carbon dioxide during the curing process and throughout its service life.

The final step involves adjusting the water content based on aggregate moisture and desired workability. This step is critical in achieving the optimal balance between strength development and carbon sequestration potential.

The resulting composition is configured to achieve a net reduction of approximately 95 tons of CO2 per 1,000 tons of concrete produced. This significant carbon reduction is accomplished through a combination of reduced CO2 inputs during production and active carbon capture during the concrete's lifecycle. For enhanced carbon dioxide sequestration capabilities, potassium hydroxide and potassium silicate can be substituted for sodium hydroxide and sodium silicate, respectively. While these potassium-based activators offer improved CO2 absorption due to their higher pH, it's important to note that they also increase the overall cost of the concrete mix.

A crucial aspect of the carbon sequestration process in accordance with an embodiment occurs during the curing phase, which typically lasts 28-60 days. During this period, the concrete actively absorbs CO2 from the surrounding air through direct air capture (DAC). This process allows the concrete to continue reducing its carbon footprint even after production.

To further enhance the concrete's carbon-negative properties, CO2 injections from industrial sources can be incorporated during the production process. These injections can come from various facilities such as ethanol, ammonia, steel, and hydrogen production plants, where CO2 is already captured in various forms. This approach not only increases the concrete's carbon sequestration capacity but also provides a beneficial recycling pathway for industrial CO2 emissions.

By combining these innovative production methods and materials, the present inventor has discovered the benefit that the produced carbon-negative concrete composition achieves a substantial reduction in CO2 emissions compared to traditional concrete production methods. The multi-faceted approach to carbon reduction and capture, including the use of industrial byproducts, carbon-sequestering additives, and active CO2 absorption during curing, sets this concrete apart from conventional mixes as a meaningful climate change mitigating improvement.

In association with various embodiments, the carbon-absorbing geopolymer concrete 100 has the following composition by weight:
35-50% geopolymers
30-45% sand
15-25% coarse aggregates, such as gravel or crushed stone
5-10% water
1-5% dried marine saltwater algae powder

### Geopolymer Aspects

The use of industrial byproducts as geopolymer precursors reduces CO2 emissions from cement production, while the integrated marine algae powder imparts carbon mineralization functionality to the concrete 100 for additional emissions offsetting.

The disclosed carbon-absorbing concrete achieves significant environmental benefits by incorporating industrial byproducts, known as geopolymers, to largely replace traditional Portland cement. Geopolymers suitable for use as primary binders include materials such as slag, fly ash, and silica fume. These are waste products resulting from various manufacturing processes involving high heat, including iron production, coal combustion, and silicon alloying. In association with an embodiment of the concrete mix, the slag comprises 30-50% of the total mix material. The remainder of the mix material comprises 30-40% gravel, approximately 35% sand, 2-5% of algae-based additives, 5-10% magnesium oxide, 5-10% calcium oxide, and approximately 10% of alkali activator. The alkali activator is comprised of approximately half sodium hydroxide and approximately half sodium silicate. The water to binder ratio associated with an embodiment is approximately 0.35-0.45.

In association with an embodiment, the method of manufacturing the carbon-sequestering geopolymer concrete composition 100 comprises first preparing a dry mixer blend. The dry mixer blend comprises ground granulated blast furnace slag, magnesium oxide powder, and calcium oxide powder (Step 1).

Concurrently, an alkali activator solution is prepared by dissolving sodium silicate and sodium hydroxide in water (Step 2).

Next, mixing of the full concrete composition 100 commences by first introducing coarse aggregates followed by sand into a concrete mixer (Step 3).

The previously prepared dry mixer blend is then gradually incorporated while mixing proceeds to ensure uniform distribution of the ground granulated blast furnace slag, magnesium oxide powder, and calcium oxide powder throughout (Step 4).

With mixing ongoing, the alkali activator solution is slowly introduced to initiate dissolution and geopolymerization reactions between the dry mixer blend and the aggregates (Step 5).

Dried algae powder is subsequently added as the final dry ingredient to supplement the binder matrix (Step 6).

Thorough mixing continues for 10-15 minutes to fully disperse all constituents and prevent segregation (Step 7).

Immediately after concluding mixing, the fresh concrete is promptly poured into prepared molds, taking care to minimize air gaps that could compromise strength (Steps 8-9).

Ideally, the filled molds should be cured at 20-25° C. for the first 24-48 hours to optimize early strength development as geopolymerization reactions proceed (Step 10).

After demolding, the concrete is estimated to fully cure in 28 days, achieving higher durability and compressive strength compared to conventional concretes.

Globally, hundreds of millions of tons of industrial byproducts are produced each year. The vast majority end up piled in landfills due to lack of reuse applications, taking up scarce landfill volume while their chemical potential remains untapped. However, when properly processed with alkali solutions, these geopolymer precursors can readily transform into reactive binders ideal for concrete manufacturing. Their innate chemical properties allow for rapid setting, accelerated curing times, and high early strength development compared to traditional concrete.

Beyond reusing waste, geopolymers offer additional advantages over Portland cement for eco-friendly construction. The production of Portland cement requires heating calcium carbonate to extremely high temperatures, resulting in the release of massive amounts of CO2. Geopolymers, in contrast, utilize waste material that has already undergone high temperature processing during initial industrial manufacturing. This eliminates the need for additional heating, curtailing further CO2 emissions. Consequently, using industrial byproduct geopolymers rather than Portland cement reduces the carbon footprint of concrete by approximately 80%.

The abundant global supply and waste reduction benefits of repurposing industrial byproducts enables massive scalability using geopolymer binders for concrete manufacturing. And the improved curing performance facilitates faster construction compared to traditional concrete. This makes geopolymer-based concrete an ideal replacement for emissions-intensive Portland cement applications.

The geopolymers used in association with embodiments of the invention include slag, fly ash class C or class F, and/or silica fume. In association with various embodiments, the relative ratios of the different geopolymers can be adjusted based on availability and cost.

In an embodiment of the invention, the geopolymer utilized comprises slag, for example ground granulated blast furnace slag. Ground granulated blast furnace slag is a byproduct of iron production from iron ore and other iron bearing materials. Using slag as a geopolymer precursor takes advantage of its latent hydraulic properties and provides a productive reuse for this industrial waste product. Slag-based binders react readily with alkali solutions, generating rapid strength development and accelerated curing times that can improve construction schedules. They also produce very durable concrete. However, slag availability may be geographically restricted based on proximity to iron production facilities. In some embodiments, an alternative geopolymer to slag may be utilized, as transport costs may be high in regions distant from slag sources.

In an embodiment of the invention, the geopolymer utilized comprises fly ash, for example Class C or Class F fly ash. Class C fly ash results from burning subbituminous coal or lignite. It has self-cementing properties in addition to pozzolanic qualities when combined with activators. This allows class C fly ash concretes to gain strength rapidly. Using class C fly ash provides a productive reuse for this abundant waste product and reduces landfill waste volumes. However, variable compositions in class C ash supplies can lead to inconsistent performance. In some embodiments where concrete strength is prioritized, an alternative geopolymer to class C fly ash may be preferable to utilize. Strict quality control testing is needed to ensure adequate reactivity and concrete strength.

Class F fly ash is a byproduct of burning anthracite or bituminous coal. It has mostly pozzolanic properties requiring activation to contribute to concrete strength. While class F ash on its own reacts slower than slag or class C ash, blending class F ash with other geopolymer precursors can provide an economic binder option. It also greatly reduces industrial waste. However, class F ash has lower innate reactivity requiring higher activator levels. In some embodiments where rapid setting times are prioritized, an alternative geopolymer to class F fly ash may be preferable to utilize. Concrete setting time may extend using high volumes of class F ash unless mix designs are precisely calibrated.

Silica fume is a byproduct of producing silicon or ferrosilicon alloys. It is very reactive pozzolan when used with alkaline solutions. Silica fume significantly improves concrete strength, permeability, and durability. However, in some environments, silica fume is not widely available and has higher cost compared to other geopolymer precursors. This limits feasibility for use as the primary binder at high replacement levels in association with some embodiments. But supplemental additions of silica fume can optimize performance.

### Sand Aspects

In association with an embodiment, sand plays an important role in the disclosed concrete mixture as a fine aggregate that improves cohesion and infills space between larger aggregates. The present inventor has recognized that the quality and properties of the sand used strongly influence fresh concrete workability as well as hardened strength and durability.

In an embodiment, the sand has a grading zone of less than 2.5 mm and be comprised of strong, hard, durable particles that are free of salts, clay, loam, and organic impurities. Both natural and manufactured sands can produce suitable performance if properly washed, graded, and tested to ensure optimal purity and particle size distribution.

The present inventor has recognized that in association with embodiments, angular, crushed sand particles with rough surface textures provide superior mechanical keying between binder paste and aggregates compared to smooth, rounded grains. However, highly angular particles can also reduce workability. Natural sand deposits with semi-angular shapes balanced with some rounded particles offer a favorable compromise. Sieve analysis should be performed per ASTM C136 to quantify particle size variation, guide necessary wash grading, and identify potential deficiencies for a given sand supply.

In addition to mechanical and chemical purity associated with an embodiment and the associated methods of production, the sand mineralogy and reactivity is assessed when specifying sand for the geopolymer concrete 100 described herein. Certain minerals can impact the alkalinity and setting reactions. Silica sands are generally compatible, while carbonate-based and feldspathic sands may react undesirably with activators. Petrographic examination provides valuable data for evaluating sand mineral suitability with the binder system.

The present inventor has recognized in association with an embodiment that with careful control of sand purity, grading, and mineralogy coupled with adjustments in activator parameters, the disclosed composition offers wide flexibility regarding locally available and cost-effective sand supplies. Testing of multiple candidate sands is recommended to optimize quality, concrete performance, and eco-friendly production.

### Coarse Aggregates (Gravel or Crushed Stone) Aspects

In association with embodiments of the invention, coarse aggregates in the form of gravel or crushed stone serve as inexpensive fillers that also greatly impact fresh and hardened concrete properties. Gravel decreases drying shrinkage while improving strength and long-term durability associated with embodiments of the concrete.

High quality gravel has strong, durable, crushed rock particles free of clay, salts, and organic matter. Preferred types of rock include granite, quartzite, basalt, limestone, and durable sandstone. In association with an embodiment, the crushing process should produce rough, angular pieces with fractured faces to enhance mechanical bonding within the concrete matrix.

Washed gravel grading sizes should range from 4 mm up to a maximum size of 20 mm in association with an embodiment. The present inventor has recognized that larger aggregates can hamper workability and consolidate poorly during placement. Sieving analysis per ASTM C136 may determine particle size distribution to blend and confirm suitable grading in association with embodiments. Uniformly graded aggregates with a wide distribution of sizes generally produce optimal packing density and concrete performance in association with an embodiment.

As in association with the sand specification in an embodiment, the mineralogy and chemical purity of coarse aggregates selected must also be vetted for compatibility with the geopolymer binder system in an embodiment. Certain minerals may react adversely with the alkaline activators, while organics or salts can inhibit setting. Testing and analysis provides guidance for evaluating aggregate suitability and minimizing incompatibilities.

With aggregate sources varying regionally, testing multiple candidate gravels allows customizing for local availability and cost-effectiveness while maintaining quality standards in association with various embodiments. Optimized aggregate selection and mixing enables the geopolymer concrete 100 to achieve exceptional strength, longevity, and carbon impact reduction in sustainable infrastructure applications in association with various embodiments.

### Water Aspects

While water serves as an essential component to enable workability and curing reactions in all concretes, its quality and properties significantly influence the behavior of geopolymer mixtures in the fresh and hardened state. Control of water chemistry and impurities is crucial for performance in association with an embodiment.

Ideally, the mixing water should be clean, potable fresh water free of oils, sugars, acids, alkalis and organic substances in association with an embodiment. The present inventor has recognized that the presence of organics can inhibit setting or reduce concrete strength. Water high in mineral content can interfere with dissolution and polycondensation reactions needed for geopolymerization and hardening. Such effects underscore the importance of starting with high purity water in association with an embodiment of the invention.

In addition to minimizing organics and dissolved solids, the source water pH, hardness and chloride ion content is carefully regulated in association with the intended method of manufacture. High pH levels introduce excess hydroxyl ions that impede polycondensation. Water hardness affects setting time, while chlorides may corrode reinforcing steel, which may play an important role in association with applications of embodiments of the invention such as in buildings and in roads. Specifying water with near neutral pH, low hardness, and chloride concentrations below 500 ppm ensures sound performance in association with an embodiment.

Though many sources may be locally available, the present inventor has recognized that municipal drinking water supplies typically offer the best economics and consistency for meeting the stringent purity and composition needs of geopolymer concrete 100 on commercial scale. Adjustments to the activator solutions can further offset minor impurities when high quality fresh water is used as the baseline mixing medium in varying embodiments.

### Algae Aspects

In association with an embodiment, dried marine saltwater algae powder is a critical component in the carbon-absorbing geopolymer concrete mixture. The algae acts as a carbon sink during the curing process, enabling significant absorption of CO2 from the surrounding air, as represented in FIGS. 1 & 2.

The dried marine saltwater algae powder algae powder acts as a carbon sink through natural chemical binding of CO2 within its cell wall structures. Key components that enable this CO2 absorption are calcium ions, magnesium ions, and alginate polymers contained within the algal cell walls.

As the concrete 100 cures, the dried marine saltwater algae powder algae powder rehydrates and partially dissolves, releasing calcium and magnesium ions along with alginate polymer chains. These ions and polymers are able to bind and chemically react with CO2 molecules that diffuse into the curing concrete from the surrounding air, as represented in FIGS. 1 and 2.

Specifically, in association with an embodiment, the chemical reactions that occur during the concrete 100 curing process are:
Ca²⁺+CO2->CaCO3
Mg²⁺+CO2->MgCO3

In these reactions, the divalent calcium ions (Ca²⁺) and magnesium ions (Mg²⁺) released from the marine saltwater algae powder react with dissolved atmospheric CO2 to form solid calcium carbonate (CaCO3) and magnesium carbonate (MgCO3) particles. These carbonate compounds are stably integrated into the concrete matrix, locking in the absorbed CO2.

In addition, the alginate polymers released from the marine saltwater algae powder can bind CO2 through formation of carbamate crosslinks. The alginate acts as a scaffold helping to convert absorbed CO2 into solid carbonate forms.

The combined effect of the algae-derived calcium, magnesium, and alginates is to chemically bind significant quantities of atmospheric CO2 as the concrete cures, absorbing it into the concrete product and achieving a carbon-negative impact.

The dried marine saltwater algae powder is produced through harvesting of marine macroalgae, which is then dried and milled into a fine powder. Species from red and brown algae groups are preferred, such as Laminaria, Ascophyllum, Sargassum, and Fucus species.

These algae species are abundant and fast growing, making them excellent candidates for sustainable harvest. The cell walls of brown and red algae contain abundant calcium and magnesium ions which react with atmospheric CO2 as the concrete cures to form stable carbonate compounds, locking away the captured carbon in the concrete matrix.

Using algae rather than seawater provides additional benefits in association with an embodiment. The high concentrations of reactive calcium and magnesium in dried marine saltwater algae powder allows for a smaller component ratio to be used in the concrete mix compared to seawater solutions. This reduces transportation costs and logistical challenges with integrating seawater, which would need to be sourced from coastal areas. Therefore, significant logistical and transportation impediments are reduced in association with embodiments of the invention.

The present inventor has recognized that using dried marine saltwater algae powder in the formulation associated with embodiments of the invention offers important advantages compared to seawater-based approaches to CO2-absorbing concrete. For example, algae cell walls contain very high concentrations of calcium, magnesium, and alginate polymers which capture CO2 as the concrete cures. The dried algae powder provides a dense, concentrated source of these reactive minerals. Seawater on the other hand is quite diluted, requiring much larger volumes of water to contribute enough calcium, magnesium and other salts to enable meaningful levels of CO2 absorption. Collecting and transporting these large volumes of seawater poses major logistical challenges and costs, especially for inland construction sites far from coastal access.

Moreover, the transportation costs and logistical barriers associated with using seawater in association with are avoided by using shelf-stable, easily transportable marine saltwater algae powder. Only small volumes of dried marine saltwater algae powder are needed to provide abundant CO2 capturing minerals. The marine saltwater algae powder's high concentration factor and stability for storage and transport provide key advantages over seawater by enabling affordable inland distribution.

Further, the drying process used to create the marine saltwater algae powder concentrates and activates the cell wall minerals to be highly reactive for binding atmospheric CO2. The drying also collapses the cell structures to facilitate rapid water permeation when rehydrated in the curing concrete, further enhancing diffusion of CO2. In contrast, seawater relies on natural diffusion of CO2 into stagnant water pockets, severely limiting absorption rates. The processed marine saltwater algae powder thus enables more efficient, higher levels of CO2 absorption during concrete curing.

Additionally, marine saltwater algae have evolved complex cell wall structures that are optimized to thrive in ocean conditions, with high salt-tolerance and more robust CO2-binding capabilities. The present inventor has recognized that this provides a key benefit in association with an embodiment of the invention. These adaptations provide significant performance benefits over the use of freshwater algae in carbon-absorbing concrete. Marine saltwater environments shape the algae to be extremely effective carbon sinks.

Finally, mass algae farming via sustainable aquaculture provides a scalable, renewable supply that can be harvested without depletion of ocean ecosystems. Seawater-based approaches have far more limited availability. The continual cultivation of fast-growing marine algae enables the production of algae powder for CO2-absorbing concrete on an industrial scale.

Further, the present inventor has recognized the advantages of using marine seawater algae over freshwater algae in association with an embodiment, in that freshwater algae species would absorb less CO2 compared to marine algae due to differences in cell wall structure and ion concentrations. Marine algae have adapted to the higher salinity ocean environment which provides more abundant ions for CO2 capture during curing.

Pre-drying the algae through solar or low-temperature drying methods into marine saltwater algae powder further enhances the reactive capabilities of the algal cell wall components, beneficial to embodiments of the invention, by enabling higher CO2 absorption rates as the concrete cures.

### Production Process

In association with an embodiment, the carbon-absorbing geopolymer concrete 100 is produced through the following steps:

Mixing the Coarse Aggregates while Dry:

In association with an embodiment, dry mixing the sand and gravel aggregates first serves several important purposes in the production process. Blending these major concrete ingredients while dry promotes uniform distribution within the particle mass before introducing water and binders. This improves consistency. Dry aggregating mixing also enables aggregate particle coating analyses to be conducted per ASTM C1260. Coating testing determines if the sand proportion effectively fills voids and encapsulates the gravel pieces without deficits or excess. Adjustments to the aggregate ratios can then be made efficiently at this stage if needed to optimize consolidated packing density in the final concrete. Homogeneous dispersion of the aggregates ahead of water addition eliminates localized variability that can occur when mixing all ingredients together from the start. Uniform aggregate distribution is critical for the concrete to achieve consistent strength and performance. Dry mixing just the sand and gravel thus allows quality control checks that ensure ideal aggregate proportions prior to committing the full batch.

### Adding the Blended Geopolymer Binder Components:

In association with an embodiment, adding and dry blending the geopolymer binder components after initial aggregate mixing allows even distribution of the slag, fly ash, and silica fume within the concrete dry ingredients. Uniform dispersion is important to maximize reactive surface area and ensure consistent reactivity of the precursor materials. Dry incorporation also enables sampling and testing to confirm composition ratios and adequate blending quality before wetting the batch. For example, samples could be examined per ASTM C136 to check particle size distribution and assess the need for any binder adjustments. Keeping the binders dry facilitates changes or corrections. Even minor segregation of binder ingredients can lead to performance variations in the final concrete. Thorough dry blending is thus an essential step to homogenize the full complement of dry constituents (aggregates and binder) ahead of alkali activator addition to lock in consistent geopolymer performance.

### Subsequently Adding the Dried Algae Powder to the Aggregates and Geopolymer Binder Components:

In association with embodiments, adding the dried marine saltwater algae powder as the final dry ingredient ensures it mixes efficiently with the other components while still dry. Algae powder is lightweight and can be prone to dusting. Incorporating it last when the other heavier aggregates and geopolymer binders have already been blended allows the algae to disperse and become embedded within the particle mixture without significant losses. Keeping the algae dry also prevents clumping or agglomeration into masses that resist separation and uniform blending. Dry homogeneous mixing is critical to distribute the microalgal powder so it can interact evenly across the binder phase and aggregates when water is introduced. This facilitates optimal formation of algal biomass-mineral composites during curing. Even minor inconsistencies in algae dispersion can lead to strength and performance variations. Adding the dried algae last when the other dry concrete constituents are already thoroughly mixed prevents segregation and ensures consistent composite properties after hardening.

Slowly Incorporating Water while Mixing to Achieve a Workable Concrete Consistency:

In association with embodiments, water addition and mixing is a critical phase defining the behavior and properties of the fresh geopolymer concrete 100. Water initiates dissolution of the binder components and allows formation of a workable matrix for placement and consolidation. However, excessive water reduces strength. The mixing water must be added gradually and carefully controlled to achieve optimum consistency without overdosing. Adding water slowly while the mixer runs allows the concrete to blend thoroughly so water penetrates all ingredients without flooding localized areas at risk for overwatering. Controlled water addition also enables the concrete consistency to be continuously evaluated as more water is introduced. Mixing continues with small measured water increments until the concrete reaches the targeted level of workability for the application without compromising the water-binder ratio. Adjustments can be made interactively to achieve the design specification. This allows customization across batches for realistic variability between constituent materials while enabling consistent performance targets. Careful water addition and mixing provides the essential quality control point to strike the needed balance between concrete workability and final strength.

Pouring the Concrete Mixture into Molds or Forms for Casting:

In association with embodiments, pouring the carbon-absorbing geopolymer concrete mixture into molds or forms is a critical step for proper casting and curing of the material. Care must be taken to maintain a continuous pour flow without interruption which could cause localized setting within the forms prior to finishing. The high heat generation associated with geopolymerization reactions necessitates coordination of pour planning and sequences to avoid excessive heat concentrations. Formwork and reinforcement requirements may also require adjustments from traditional portland cement concrete designs to account for the unique properties of the geopolymer matrix. Testing should guide specification development to optimize mixture proportions and placement procedures for the intended application and curing conditions. With appropriate handling, the reactive properties of the concrete that enable enhanced carbon mineralization can be leveraged for casting of structural and durable infrastructure elements.

When pouring the carbon-absorbing geopolymer concrete 100 for building construction applications such as those depicted in FIGS. 1 and 2, the mixture can be cast into forms erected onsite to mold walls or structural elements per the project plans. The reactive properties of the concrete mixture necessitate continuous flows during pouring to prevent setting prior to consolidation and finishing within the forms. Multi-yard buckets raised by tower cranes may be used to convey and distribute the concrete to appropriate locations without interruption. The higher heat generation associated with geopolymerization reactions compared to traditional portland cement dictates additional care when planning pour sequences to avoid excessive heat buildup within any given formwork section that could cause cracking.

For road and sidewalk construction requiring reinforcement, the geopolymer concrete 100 can be poured over rebar mats laid over compacted grade in coordinated blocks matching pour sequences to traffic access needs. The concrete would then be finished to specified highway profiles. Rebar spacing and concrete cover thickness may require adjustment from traditional designs to account for the unique properties of the geopolymer matrix. Test pours should be performed to optimize placement procedures when using the concrete for transportation department projects.

When pouring the geopolymer concrete 100 for sidewalk or flatwork applications, such as that depicted in FIG. 1, the same basic principles apply in terms of continuous flows from mixers or buckets to avoid setting prior to screeding and finishing. However, the smaller volumetric flow rates enable direct chute discharges from portable mixers positioned proximate to the targeted placement area. The higher heat of hydration requires pour planning coordination to sequence progressive linear sections accordingly. The environmental exposure conditions associated with exterior hardscapes may also dictate adjusted mixture proportions to achieve required performance.

Allowing an initial hardening and drying process during which the marine saltwater algae powder absorbs CO2 directly from the air through natural chemical reactions with the geopolymer compounds.

In association with embodiments, allowing the freshly poured geopolymer-algae concrete to undergo initial hardening enables unique carbon mineralization processes. As the alkaline activation reactions proceed to set the binder matrix, the incorporated algal biomass provides reactive sites to facilitate additional carbonation curing. The algae contain organic compounds and functional groups that can bond and stabilize atmospheric CO2 through natural chemical interactions with the geopolymeric gel phases forming in the matrix pore structure. This complementary curing mechanism allows the concrete to directly absorb and mineralize carbon dioxide from the surrounding air.

The present inventor has recognized that letting this initial carbonation process occur without disturbance accelerates strength buildup in the material. The additional CO2 precipitation and carbonate formation provides supplementary binding and densification that supplements the geopolymerization polymer crosslinking. This carbon-enhanced curing regime enhances durability while progressively removing CO2 from the environment. Furthermore, the algal components help trap the mineralized carbon in a stable bio-composite, preventing re-release of the greenhouse gas. Allowing this in situ carbon mineralization to initially advance before moving or exposing the freshly cast concrete elements enables maximum carbon uptake.

Timing this initial curing period requires balancing early strength gain and carbonation against construction scheduling constraints. Testing can help characterize these competing dynamics and define an optimal initial hardening duration before demolding, transport, or finishing procedures are conducted. This demonstrates the importance of aligning project specifications and logistics to take full advantage of the carbon absorption capacities intrinsic to the algae-bearing geopolymer concrete 100. The geopolymer concrete 100 can be further finished and processed as per standard concrete methods once initially hardened and cured.

Continuing Absorbing of Atmospheric Carbon Dioxide Through Ongoing Reactions with the Algal Components Over the Concrete's Service Life:

In association with embodiments, even after the initial curing stage, the algae embedded within the hardened geopolymer concrete 100 matrix provide an avenue for continued carbon mineralization over time. The algal cell structures and biomolecules maintain carbon-sequestering function for an extended duration by enabling ongoing chemical interactions with CO2 diffusing into the concrete from the surrounding environment.

This persistent carbon absorption capacity stems from the unique bio-receptivity of algal compounds to bond with atmospheric carbon dioxide. As CO2 permeates the concrete, the algal components facilitate precipitation and stabilization of calcium carbonate deposits that incrementally fill micropores within the binder matrix. This self-replenishing capacity for carbon mineralization leads to excellent in-service durability while progressively extracting CO2 from the atmosphere.

Engineering the geopolymer-algae concrete system to optimize this continuing carbon sequestration pathway allows infrastructure elements to act as durable carbon sinks over their lifetime. While the absorption rate tapers, the cumulative CO2 removal can be substantial. Specifying higher algae content may enhance ongoing carbonation capacity depending on application constraints. Regardless, the algae-bearing geopolymer concrete 100 demonstrates persistent carbon mineralization translating to reduced atmospheric greenhouse gas levels over time.

### Chemical Reactions

In association with embodiments, and especially during the curing process, the following chemical reactions occur which enable CO2 capture from the air into the concrete:
CaO+CO2->CaCO3
MgO+CO2->MgCO3

The calcium oxide and magnesium oxide are reactive components provided by the geopolymers and algae powder. They undergo carbonation reactions with atmospheric CO2 to form stable carbonates which are integrated into the concrete structure.

The geopolymeric binder and algal components in the carbon-mineralizing concrete in embodiments provide reactive substrates to facilitate carbon dioxide capture from the air through carbonation. As CO2 diffuses into the pore network during initial curing, key oxides drive mineral carbonate formation:

Calcium oxide (CaO)—Originating from the algae/biomass ash and supplementary cementitious materials in the geopolymer, CaO reacts with absorbed CO2 to form calcium carbonate (CaCO3). This stable carbonate integrates into the binder matrix, supplementing the polymer structures.

Magnesium oxide (MgO)—Similarly, MgO phases in the algal ash and geopolymer constituents carbonate upon exposure to CO2, forming magnesium carbonates (MgCO3). These carbonates contribute to binder consolidation while storing absorbed CO2.

By providing reactive CaO and MgO precursor sites throughout the concrete mixture, the algae and geopolymeric compounds facilitate in situ carbon mineralization. The resulting carbonates lock in absorbed CO2 while enhancing matrix cohesion. This self-driven curing mechanism is central to capturing airborne CO2 and embedding it within the robust concrete structure.

Optimizing the blend of algae, geopolymers, and supplementary cementitious materials can maximize CaO and MgO availability in various embodiments. More of these reactive oxide phases promotes additional carbonate precipitation and CO2 uptake capacity. This empowers durable concrete elements to act as carbon sinks during service by leveraging intrinsic mineral carbonation reactivity.

Optimizing the geopolymer-algae concrete composition 100 to maximize carbon mineralization potential can follow several approaches in association with various embodiments. Increasing the algae content used as a supplementary cementitious material provides more reactive calcium oxide (CaO) and magnesium oxide (MgO) upon combustion of the biomass. With higher concentrations of these oxides distributed throughout the binder matrix, additional carbonation sites are available as atmospheric carbon dioxide permeates into the pore structures of the curing concrete. More CaO and MgO facilitates further carbonate precipitation to lock in the absorbed CO2.

Additionally, the formulation of the geopolymeric source materials can be tuned to offer tailored CaO, MgO and other oxide contents. Certain natural pozzolans or slag-based precursors can provide reactive components that supplement the algae-derived phases. This allows the alkali-activated aluminosilicate chemistry to be optimized to impart mineral carbonation capacity beyond the algal biomass alone.

Incorporating interground limestone powder is another route to directly introduce supplementary CaO that enables further carbonation upon exposure to CO2. Optimizing the fineness and dosage of limestone additions in context of the full binder blend promotes additional carbon dioxide uptake driven by the added oxide content. Interground limestone powder would be more ideally incorporated into the geopolymeric source materials rather than the coarse aggregates when aiming to optimize carbon mineralization in the geopolymer-algae concrete system.

Adding fine limestone powder directly to the geopolymeric precursor allows dispersion throughout the binder matrix as it cures. This enables abundant calcium oxide reactivity that facilitates carbonation upon exposure to CO2 diffusing into the concrete. Uniform distribution of the limestone-derived CaO throughout the binder phase provides consistent carbonation potential.

Therefore intergrinding limestone into the geopolymeric aluminosilicate precursors in association with an embodiment, along with the algae as supplementary cementitious material, allows reliable enhancement of carbon dioxide absorption during curing and beyond. The fine powder dispersion promotes accessible and evenly distributed CaO content, enabling consistent mineral carbonate formation as atmospheric CO2 permeates the concrete over time.

Furthermore, substituting dolomitic aggregates contributes both CaO and MgO into the geopolymer matrix by dissolution. With this added source of oxides dispersed throughout the binder via the aggregates, supplementary mineral carbonation sites are provided to facilitate greater CO2 absorption.

These compositional modifications gear the hybrid geopolymer-algae concrete system to offer abundant CaO and MgO availability that drives more extensive carbonate formation. By aligning the complementary reactivities across algae, geopolymeric and cementitious components, the carbon dioxide sequestration potential reaches full utilization. This allows durable infrastructure elements to maximize service life while acting as carbon sinks.

In an example, an idealized geopolymer-algae concrete blend as an embodiment of the invention for maximized carbon mineralization could comprise:
65% coarse and fine aggregates (with 30% dolomitic sand)
20% alkali-activated slag and metakaolin geopolymeric binder
10% interground limestone powder
5% algal biomass ash as supplementary cementitious material

This exemplary formulation provides an optimal ratio of components to facilitate abundant carbon dioxide uptake during curing and beyond. The dolomitic sand contributes reactive MgO and CaO upon dissolution into the geopolymer matrix, while the algae and limestone powder both supplement additional oxide content dispersed throughout the binder.

With plentiful CaO and MgO availability, carbonation potential is maximized as atmospheric CO2 diffuses into the concrete over time. This drives extensive precipitated carbonate formation to stably capture the absorbed CO2. Meanwhile, the balanced blend of slag and metakaolin-based geopolymer binder offers a robust crosslinked matrix to consolidate the developing carbonate structures.

The result is durable concrete with maximized carbon sink characteristics, owing to optimized reactivity between algae, geopolymers, and supplementary cementitious constituents. Tuning the proportions of these complementary components allows the full CO2 mineralization capacity to be utilized for enhanced carbon-negative performance. This makes the material suitable for sustainable infrastructure applications requiring reliable carbon absorption.

In association with various embodiments of the invention, and to facilitate optimization of the associated components to the ideal ratios given variations in the inputs, multi-faceted analytical approach can systematically evaluate the carbon dioxide sequestration performance of optimized geopolymer-algae concrete formulations. In an example, gravimetric testing directly quantifies CO2 uptake through precise measurement of concrete sample mass change when subjected to controlled carbon dioxide exposure conditions. This determines the overall carbon mineralization capacity. Additionally, complementary thermogravimetric analysis provides insight into carbonate content and conversion efficiency by detecting the carbon dioxide released when heating concrete powder samples. Quantifying the liberated CO2 assesses how much has been stably incorporated into precipitated carbonate compounds. X-ray diffraction analysis of the concrete's mineral composition identifies which carbonate phases have formed during CO₂ curing. Monitoring the intensity of carbonate diffraction peaks over time also reveals carbonation kinetics and mechanisms. Scanning electron microscopy offers visual microstructural verification of carbonate formation, distribution and integration within the binder matrix, indicating how the pore structure evolves as a result of CO2 absorption. Finally, Raman spectroscopy spatially maps carbonates precipitated throughout intact concrete samples by detecting associated molecular vibrations. The combination of these analytical techniques is intended to provide comprehensive evaluation of the dynamic carbon dioxide uptake and progressive carbonation processes occurring in optimized geopolymer-algae concrete as it acts as a carbon sink in association with various embodiments, and thereby facilitates comparison and optimization of the associated material inputs and ratios.

### 30-Story Building Example and Benefits

Particularly as urban centers continue expanding vertically, high-rise construction drives massive demand for concrete to build durable structures. For a typical 30-story building, over 158 million pounds of concrete are required just for the foundational and structural elements. Historically, this has relied solely on conventional Portland cement concrete mixes. However, the significant carbon footprint accompanying production of these standard concretes presents sustainability issues. To align large-scale buildings with global emissions reductions goals, alternative technologies are critically needed. Embodiments of the invention comprising the carbon-mineralizing geopolymer-algae concrete described herein may transform high-rise construction's impacts. By both minimizing the emissions associated with production and actively absorbing CO2 from the atmosphere, the technology offers carbon-negative performance unmatched by many traditional materials. For structures like 30-story towers requiring massive concrete volumes, these carbon-reducing attributes can drive measurable progress towards carbon-neutral built environments at urban scale.

Constructing a typical 30-story building requires a substantial amount of concrete, estimated at nearly 159 million pounds. Using conventional Portland cement formulations, the greenhouse gas emissions associated with concrete production for such a structure are significant. Each pound of standard concrete generates around 0.93 lbs. of carbon dioxide emissions during manufacturing. For the quantity needed for a 30-story high-rise, this equates to almost 148 million pounds of carbon dioxide emitted just from concrete production alone. Exemplary emissions associated with the construction of a 30-story building with prior art concrete formulations are:
Concrete needed: 158,800,000 lbs
CO2 per lb concrete: 0.93 lbs
Total CO2=158,800,000 lbs. concrete×0.93 lbs. CO2/lb concrete=147,700,000 lbs. CO2

Shifting to an building comprising an embodiment of the invention, with an optimized geopolymer-algae concrete blend as described herein, could dramatically curb adverse carbon impacts associated with building construction. With enhanced CO2 mineralization capacity compared to traditional concrete, the present inventor has recognized that an embodiment of the invention absorbs over 50 lbs. of carbon dioxide per cubic yard. Implementation of embodiments in the form of a 30-story high rise, wherein structural elements incorporate the carbon-sequestering concrete described herein, could feasibly sequester over 35 million lbs. of CO2. This offsets nearly a quarter of the emissions otherwise linked to conventional concrete production at such a scale. Furthermore, the present inventor has recognized that the incorporation of industrial byproduct geopolymers and algal biomass in association with various embodiments of the invention enables additional circular economy benefits.

Implementing carbon-negative geopolymer-algae concrete systems for such large buildings in association with embodiments of the invention exemplifies an impactful route towards sustainable construction. The improved carbon accounting compared to traditional materials helps address infrastructure's share of global emissions, while enhancing durability and mechanical performance over conventional concrete.

By incorporating industrial byproduct slag and fly ash as the geopolymeric precursors in association with embodiments of the invention, CO2 emissions during manufacturing are reduced to approximately 0.25 lbs. per pound of concrete. For a 30-story building's concrete needs, this approximately equates to under 40 million pounds of production emissions-far less than standard mixes (especially those incorporating Portland cement). Furthermore, the algal biomass content enables additional carbon dioxide absorption benefits.

As the geopolymer-algae concrete cures, the dried algae powder is estimated to sequester about 0.8 lbs. of CO2 per pound of concrete. At the scale of a 30-story building, the total absorption capacity of the concrete as an embodiment of the invention is over 127 million lbs. of CO2. In further optimized examples, this absorption may exceed the emissions, giving the material carbon-negative credentials.

Accounting for both the reduced emissions from geopolymer production and the enhanced algae-driven carbon uptake, the net CO2 impact for a 30-story building's concrete requirements would be an estimated 32 million pound deficit. Rather than contributing over 147 million pounds of emissions as prior art concrete incorporating Portland cement would, in embodiments of the invention, the geopolymer-algae concrete system could actively absorb up to 95 million more pounds of CO2 than it emits. This exemplifies the technology's potential to transform conventional concrete's carbon footprint for next-generation sustainable construction.

### Exemplary Implementation: Highway/Road Construction

Building extensive highway networks and urban road infrastructure necessitates substantial concrete usage, historically relying on conventional Portland cement. For example, a typical 4-lane, 1-mile highway stretch requires over 25 million lbs. of concrete for pavements and structures. At standard emissions rates, this concrete's production would generate nearly 24 million lbs. of carbon dioxide. By incorporating industrial byproduct geopolymers and algal additives, our novel concrete mix reduces the CO2 footprint of such road projects by over 80%. Enhanced carbon mineralization also enables the pavement to actively absorb ambient CO2 during service life. Implementing the technology across nationwide road construction would mitigate over many millions tons per year of CO2 emissions, supporting sustainability in infrastructure expansion.

The high compressive and flexural strengths of the carbon-absorbing concrete embodiments described herein also provide superior technical performance for roads and bridges compared to existing alternatives. This durability translates into extended service lifetimes with reduced maintenance frequency. The enhanced longevity and corrosion resistance ensures highway integrity is preserved for longer periods before repavement or reconstruction is needed. This creates additional savings in materials, costs and emissions over the full structure lifecycles.

### Exemplary Implementation: Sidewalk Construction

Sidewalks and walkways are prime candidates to incorporate the carbon-mineralizing concrete technology described herein. It is an embodiment of the invention to provide a sidewalk comprising the concrete described herein. Many millions of square feet of sidewalks are poured nationally each year, primarily using conventional concrete mixes. Adopting the geopolymer-algae concrete formulations as described herein for pedestrian infrastructure projects would significantly reduce CO2 emissions.

The typical sidewalk slab requires around 0.05 cubic yards of concrete per square foot laid. With an average thickness around 4 inches, the geopolymer-algae concrete mix described herein can be readily poured and finished using existing construction techniques. The present inventor algae additive also enhances the freeze-thaw resilience critical for concrete exposed to winter conditions. It is therefore an aspect of the invention to provide a sidewalk with enhanced freeze-thaw resilience comprising the concrete described herein.

In association with embodiments of the invention, over a typical 50-year service lifetime, each cubic yard of our geopolymer-algae concrete sidewalk slab sequesters up to 30 lbs. of ambient CO2. Widescale adoption in the United States of sidewalk embodiments of the invention could cumulatively remove over 120 million tons of CO2 from the atmosphere. This embodied carbon absorption combines with over 70% lower emissions during manufacturing compared to traditional mixes. The technology is thereby ideally suited to transform the environmental impacts of sidewalk construction.

With urban pedestrian infrastructure renewal projects ongoing year-round globally, specifying the concrete technology associated with embodiments in sidewalk construction can rapidly scale emissions mitigation across this sector. The present inventor has recognized that the ease of integration associated with embodiments of the invention with existing pouring and finishing equipment facilitates rapid adoption around sidewalks, walkways and related structures. This enables progressive built environment entities to cost-effectively tap into an embodiment's immense carbon reduction opportunities.

A key aspect of embodiments of the invention is enabling the finished pedestrian infrastructure to persistently sequester carbon dioxide from the air during its service lifetime through ongoing mineralization reactions. This is achieved by incorporating 1-5% dried marine saltwater algae powder into the geopolymer-concrete mixture prior to pouring. As the concrete cures in the form of a sidewalk in association with an embodiment, components of the algae cell walls dissolve into the binder matrix, providing abundant calcium ions, magnesium ions and alginate polymer chains with high affinity for carbon dioxide. Over the estimated 50 year sidewalk lifetime, atmospheric CO2 is able to gradually diffuse into and permeate through the slab. During periodic wetting and drying cycles, this CO2 interacts with the algae-derived ions and polymers, undergoing natural carbon mineralization processes. The dissolved CO2 chemically precipitates into stable, insoluble solid carbonate compounds integrated within the concrete structure. These carbonate precipitates include calcium carbonate (CaCO3) and magnesium carbonate (MgCO3) particles that stably lock in the absorbed CO2 for extended timeframes, enabling persistent carbon sequestration over the full service duration.

In accordance with an embodiment of the invention comprising a method of reducing carbon dioxide emissions in concrete production, the method can be implemented through the following process:

First, the concrete composition is produced as described herein comprising Class F fly ash, ground granulated blast furnace slag (GGBFS), metakaolin, recycled coarse aggregates, natural fine aggregates, sodium hydroxide and sodium silicate solutions, and various carbon sequestration additives such as algae biomass, calcium carbonate, magnesium carbonate, olivine, basalt rock dust, biochar, and alginate beads

Once the concrete is mixed, it is allowed to cure for a period of 28-60 days. During this curing phase, the concrete actively absorbs CO2 from the surrounding air through a process known as direct air capture (DAC). This initial carbonation process occurs without disturbance and accelerates strength buildup in the material while simultaneously removing CO2 from the environment.

To further enhance the carbon sequestration capabilities of the concrete, CO2 injections from industrial sources are incorporated into the composition. These injections can come from various facilities such as ethanol, ammonia, steel, and hydrogen production plants, where CO2 is already captured in various forms. This approach not only increases the concrete's carbon sequestration capacity but also provides a beneficial recycling pathway for industrial CO2 emissions.

The combination of these processes—the initial production using low-carbon materials, the absorption of atmospheric CO2 during curing, and the incorporation of industrial CO2-results in a net reduction of approximately 95 tons of CO2 per 1,000 tons of concrete produced. This significant carbon reduction is achieved through both the reduction of CO2 inputs during production (approximately 107.75 tons per 1000 tons of concrete produced) and the active capture of additional CO2 (approximately 200 tons per 1000 tons of concrete produced) throughout the concrete's lifecycle.

This method represents a substantial improvement over traditional concrete production techniques, offering a viable pathway to dramatically reduce the carbon footprint of the construction industry. The multi-faceted approach to carbon reduction and capture sets this concrete apart from conventional mixes and positions it as a significant advancement in sustainable construction materials.

The present inventor has discovered benefits of embodiments including those relevant to the embodiments described herein through experimentation and observation.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents, including the inclusion of plural or singular aspects of the system otherwise than as described herein. It is intended that the following claims define the scope of the invention and that methods and structures within the scope of these claims and their equivalents be covered thereby.

I claim:

1. A carbon-negative concrete composition comprising:
7-13% Class F fly ash;
5-10% ground granulated blast furnace slag (GGBFS);
1-4% metakaolin;
35-45% recycled coarse aggregates;
35-45% natural fine aggregates;
1-4% sodium hydroxide solution;
1-4% sodium silicate solution;
0.3-3% of algae biomass,
0.3-3% of at least one or more of the group consisting of calcium carbonate and magnesium carbonate;
0.2-2.5% of at least one or more of the group consisting of olivine, basalt rock dust, biochar, and alginate beads;
3-20% water;
wherein the composition is configured to reduce CO2 inputs by approximately 80-130 tons and capture an additional 150-250 tons of CO2 per 1,000 tons of concrete produced.

2. The composition of claim 1, wherein potassium hydroxide and potassium silicate are substituted for sodium hydroxide and sodium silicate, respectively.

3. The composition of claim 1, wherein the composition is configured to achieve a net reduction of approximately 95 tons of CO2 per 1,000 tons of concrete produced.

4. The composition of claim 1, wherein the composition is configured to absorb CO2 from surrounding air through direct air capture (DAC) during an initial curing phase lasting 28-60 days.

5. The composition of claim 1, further configured to incorporate CO2 injections from industrial sources including ethanol, ammonia, steel, and hydrogen production facilities.

6. The composition of claim 1, wherein the composition is entirely Portland cement-free.

7. A method of producing a carbon-negative concrete composition comprising:
combining Class F fly ash, ground granulated blast furnace slag (GGBFS), and
metakaolin to form a binder system;
mixing recycled coarse aggregates and natural fine aggregates;
adding sodium hydroxide solution and sodium silicate solution as alkaline activators;
incorporating carbon sequestration additives including algae biomass, calcium carbonate, magnesium carbonate, olivine, basalt rock dust, biochar, and alginate beads;
adjusting water content based on aggregate moisture and desired workability;
wherein the resulting composition is configured to achieve a net reduction of approximately 95 tons of CO2 per 1,000 tons of concrete produced.

8. The method of claim 7, further comprising substituting potassium hydroxide and potassium silicate for sodium hydroxide and sodium silicate, respectively.

9. The method of claim 7, further comprising allowing the composition to cure for 28-60 days, during which time it absorbs CO2 from surrounding air through direct air capture (DAC).

10. The method of claim 7, further comprising incorporating CO2 injections from industrial sources during the production process.

11. A carbon-negative concrete system comprising:
the concrete composition of claim 1;
a curing environment configured to allow the concrete composition to absorb CO2 from surrounding air for 28-60 days; and
an injection system configured to incorporate CO2 from industrial sources into the concrete composition.

12. The system of claim 11, wherein the concrete composition is configured to be used in building applications.

13. The system of claim 11, wherein the concrete composition is configured to be used in sidewalk applications.

14. A method of reducing carbon dioxide emissions in concrete production comprising:
producing a concrete composition as claimed in claim 1;
allowing the composition to cure for 28-60 days while absorbing CO2 from surrounding air;
incorporating CO2 injections from industrial sources into the composition;
wherein the method achieves a net reduction of approximately 95 tons of CO2 per 1,000 tons of concrete produced.

15. A carbon-negative concrete composition consisting essentially of:
Class F fly ash, ground granulated blast furnace slag (GGBFS), and metakaolin as binder materials;
recycled coarse aggregates and natural fine aggregates;
sodium hydroxide solution and sodium silicate solution as alkaline activators;
algae biomass, calcium carbonate, magnesium carbonate, olivine, basalt rock dust, biochar, and alginate beads as carbon sequestration additives;
water,
wherein the composition contains no Portland cement and is configured to achieve a net reduction of approximately 95 tons of CO2 per 1,000 tons of concrete produced.
